(19) United States
(12) Patent Application Publication
(10) Pub. No.: US 2010/0273686 A1
(43) Pub. Date: Oct. 28, 2010

(54) MOLDING MATERIAL FOR BEARING, BEARING AND SUBMERSIBLE PUMP

(76) Inventor: Makoto Nakabayashi, Sennan-gun (JP)

Correspondence Address: MCDERMOTT WILL & EMERY LLP, 600 13TH STREET, N.W., WASHINGTON, DC, 20005-3096, US

(21) Appl. No.: 12/439,358

(22) PCT Filed: Aug. 23, 2007
(86) PCT No.: PCT/JP2007/066379

§ 371 Date: Jun. 30, 2010

(30) Foreign Application Priority Data
Aug. 28, 2006 (JP) 2006-231060
Feb. 28, 2007 (JP) 2007-048813

(51) Int. Cl. F16C 33/66

(52) U.S. Cl. 508/106; 508/100

(57) ABSTRACT

An object of the present invention is to provide a molding material for bearing that is excellent in moldability, that does not cause the problem of SOx generation, that has high slidability and excellent abrasion resistance, and that provides a bearing having chemical resistance and heat resistance that are equal to or higher than those of a bearing formed with polyphenylene sulfide; a bearing produced with the molding material for bearing and used for a pump; and a submersible pump including the bearing.

A molding material for bearing according to the present invention includes, as main components, a polymer that does not contain sulfur in a main chain and has a storage elastic modulus of 1×10⁶ Pa or more at 260° C. and a solid lubricant wherein a molded product obtained by molding the molding material has a coefficient of dynamic friction of 0.05 or less against stainless steel in a 50% aqueous solution of ethylene glycol at 30° C.

### TECHNICAL FIELD

The present invention relates to a molding material for forming a bearing of a submersible pump that is used for cooling water cycling in an automotive cooler or the like. The present invention also relates to a bearing obtained by molding such a molding material for bearing and a submersible pump including such a bearing.

### BACKGROUND ART

The following properties are desired for a bearing of a submersible pump that is used for cooling water cycling in an automotive cooler.

The properties include:

a low friction coefficient (high slidability) in underwater sliding for fuel saving in an automobile,

excellent abrasion resistance,

excellent creep resistance for reducing the occurrence of deformation (creep) of a bearing that is used for a long period of time because such deformation leads to frequent replacement of the bearing over time,

chemical resistance because the submersible pump is used for cycling an antifreeze solution containing a chemical agent such as ethylene glycol, and

long-term heat resistance and long-term cold temperature resistance with which a bearing does not suffer from deterioration in a use environment at high temperatures of about 105° C. to 110° C. and at low temperatures of −40° C. to −30° C.

Such a bearing is integrated with an impeller and a magnet for rotary drive. This integration is often achieved by insert molding with a thermoplastic resin. For this reason, short-term heat resistance to heat of a molten resin during insert molding may also be required for such a bearing.

For a molding material for forming a bearing satisfying these properties, for example, a material obtained by mixing engineering plastics with lubricant oil and a solid lubricant is proposed. A bearing is known that is constituted by a molded product obtained by molding this molding material and subsequently subjecting the molded material to radiation irradiation (Patent Document 1). Examples of the engineering plastics include nylon, polyphenylene ether, and polyphenylene sulfide. Examples of the solid lubricant include molybdenum disulfide, graphite, ultrahigh molecular weight polyethylene, and polytetrafluoroethylene (hereinafter, referred to as “PTFE”).

[Patent Document 1] Japanese Unexamined Patent Application Publication No. 2002-155154

### DISCLOSURE OF INVENTION

### Problems to be Solved by the Invention

A bearing formed by using polyphenylene sulfide among the engineering plastics is particularly excellent in chemical resistance and short-term heat resistance. Unfortunately, a molding material for bearing containing polyphenylene sulfide has poor moldability and generates SOx during molding, thereby decreasing the duration of the life of a mold die. For this reason, there is a demand for a molding material that does not contain polyphenylene sulfide and hence does not cause the problem of SOx generation, that can provide a bearing having chemical resistance and short-term heat resistance that are equal to or higher than those of a bearing formed with polyphenylene sulfide, and that is excellent in moldability.

Accordingly, an object of the present invention is to provide a molding material for bearing that does not contain polyphenylene sulfide and hence does not cause the problem of SOx generation; that is excellent in moldability; that has high slidability, excellent abrasion resistance, good long-term heat resistance, and good long-term cold temperature resistance; that can provide a bearing having chemical resistance and short-term heat resistance that are equal to or higher than those of a bearing formed with polyphenylene sulfide. Another object of the present invention is to provide a bearing for a submersible pump, the bearing being obtained by molding such a molding material for bearing, and a submersible pump including such a bearing.

### Means for Solving the Problems

The inventor of the present invention has performed thorough studies to achieve the following finding. Even when a molding material composed of a polymer not containing sulfur in the main chain, that is, a molding material that does not cause the problem of SOx generation during molding, is used, combination of a polymer having a storage elastic modulus of 1×10⁶ Pa or more at 260° C. and a solid lubricant such as a fluorine resin permits formation of a bearing having high slidability, excellent abrasion resistance, and chemical resistance and heat resistance that are equal to or higher than those of a bearing formed with polyphenylene sulfide. Thus, the inventor has accomplished the present invention.

A first aspect of invention of the present application provides a molding material for bearing including, as main components, a polymer that does not contain sulfur in a main chain and has a storage elastic modulus of 1×10⁶ Pa or more at 260° C. and a solid lubricant, wherein a molded product obtained by molding the molding material has a coefficient of dynamic friction of 0.05 or less against stainless steel in a 50% aqueous solution of ethylene glycol at 30° C.

A bearing obtained by molding the molding material for bearing has a coefficient of dynamic friction of 0.05 or less against stainless steel in a 50% aqueous solution of ethylene glycol at 30° C. Thus, the bearing has high slidability and excellent abrasion resistance and can be suitably used as a bearing of a submersible pump for cycling a long life coolant (LLC) mainly containing an aqueous solution of ethylene glycol.

An example of the polymer that does not contain sulfur in the main chain and has a storage elastic modulus of 1×10⁶ Pa or more at 260° C. is a polymer of cyclic olefin (cyclic polyolefin) (a second aspect of invention of the present application). A polymer of cyclic olefin can be made to have a storage elastic modulus of 1×10⁶ Pa or more at 260° C. by adjusting the molecular weight of the polymer or by subjecting the polymer to cross-link described below and adjusting the degree of cross-linking of the polymer. Appropriate conditions for adjusting the molecular weight and for the cross-link can be readily obtained from known data or a simple pretest.

A bearing obtained by using a polymer of cyclic olefin is excellent in chemical resistance, resistant to deterioration even after long-term usage for cycling coolant water containing a chemical agent such as ethylene glycol, and has low probability of causing problems such as a decrease in the mechanical strength or generation of creep or cracks. In particular, such a bearing exhibits excellent long-term heat resistance and is usable for a long period of time at high temperatures of about 105° C. to 110° C.

Herein, the cyclic olefin is a known monomer, for example, those described in Japanese Unexamined Patent Application Publication No. 08-20692. Preferred examples of the cyclic olefin include cyclopentene, 2-norbornene, and a compound (monomer) including a cyclotetradodecene-based structure (a third aspect of invention of the present application).

Specifically, examples of the cyclic olefin include 2-norbornene, 5-methyl-2-norbornene, 5,5-dimethyl-2-norbornene, 5-ethyl-2-norbornene, 5-butyl-2-norbornene, 5-ethylidene-2-norbornene, 5-methoxycarbonyl-2-norbornene, 5-cyano-2-norbornene, 5-methyl-5-methoxycarbonyl-2-norbornene, 5-phenyl-2-norbornene, 5-phenyl-5-methyl-2-norbornene, dicyclopentadiene, 2,3-dihydrodicyclopentadiene, tetracyclo-3-dodecene, 8-methyltetracyclo-3-dodecene, 8-ethyltetracyclo-3-dodecene, 8-hexyltetracyclo-3-dodecene, 2,10-dimethyltetracyclo-3-dodecene, 5,10-dimethyltetracyclo-3-dodecene, 1,4:5,8-dimethano-1,2,3,4,4a,5,8,8a,-2,3-cyclopentadienonaphthalene, 6-ethyl-1,4:5,8-dimethano-1,4,4a,5,6,7,8,8a,-octahydronaphthalene, and 1, 4:5, 10:6, 9-trimethano-1,2,3,4,4a,5,5a,6,9,9a,10,10a-dodecahydro-2,3-cyclopentadienoanthracene.

The polymer of cyclic olefin may be a homopolymer of the cyclic olefin described above or a copolymer of a monomer having an unsaturated group copolymerizable with a cyclic olefin and a cyclic olefin. Alternatively, the polymer of cyclic olefin may also be a polymer containing two or more types of cyclic olefins. In this case, the storage elastic modulus at 260° C. of the polymer can also be adjusted by selecting the types of monomers to be copolymerized or adjusting the copolymerization ratio of the monomers.

Examples of a monomer, other than cyclic olefin, that constitutes a copolymer of cyclic olefin include alpha-olefins such as ethylene, propylene, 1-butene, 3-methyl-1-butene, 1-pentene, 3-methyl-1-pentene, 4-methyl-1-pentene, 1-hexene, 1-octene, 1-decene, 1-dodecen, 1-tetradecene, 1-hexadecene, and 1-icosen;

unsaturated carboxylic acids such as acrylic acid, methacrylic acid, maleic acid, fumaric acid, itaconic acid, citraconic acid, tetrahydrophthalic acid, and methyltetrahydrophthalic acid;

acrylates and methacrylates such as methyl acrylate, ethyl acrylate, hydroxyethyl acrylate, methyl methacrylate, ethyl methacrylate, and hydroxyethyl methacrylate;

unsaturated diester dicarboxylates such as dimethyl maleate, dimethyl fumarate, diethyl itaconate, and dimethyl citraconic acid;

unsaturated carboxylic acid anhydrides such as maleic acid anhydride, itaconic anhydride, citraconic anhydride, tetrahydrophthalic anhydride, and methyltetrahydrophthalic anhydride;

vinyl alcohol and vinyl esters such as vinyl alcohol and vinyl acetate; and

styrenes such as styrene and α-methylstyrene.

Among cyclic polyolefins, copolymers containing cyclic olefin in 10 to 60 mole % on the basis of monomers exhibit excellent short-term heat resistance. When the proportion of cyclic olefin is more than 60 mole %, the occurrence of cross-linking is reduced in the molding material for bearing. In contrast, when the proportion of cyclic olefin is less than 10 mole %, the molding material for bearing exhibits poor moldability and the resultant molded products have insufficient stiffness and low Tg.

Copolymers of cyclic olefin can be produced, for example, by a method of subjecting the cyclic olefins and the monomers other than cyclic olefin described above to random addition-copolymerization. For polymerization conditions relating to a catalyst, a solvent, and reaction temperature, and the like in production of cyclic polyolefins, known conditions described in Japanese Unexamined Patent Application Publication No. 08-20692 or the like can be used.

The range of the molecular weight of a cyclic polyolefin is not particularly restricted as long as the cyclic polyolefin can be made to have a storage elastic modulus of 1×10⁶ Pa or more at 260° C. The larger the molecular weight, the more the enhancement in abrasion resistance, short-term heat resistance, long-term heat resistance, cold temperature resistance, and chemical resistance, whereas the larger the degradation in moldability.

In consideration of these properties, molecular weight is optimally selected.

Syndiotactic polystyrene is another polymer that does not contain sulfur in the main chain and has a storage elastic modulus of 1×10⁶ Pa or more at 260° C. (a fourth aspect of invention of the present application). Syndiotactic polystyrene can also be made to have a storage elastic modulus of 1×10⁶ Pa or more at 260° C. by adjusting the degree of crystallinity of the syndiotactic polystyrene or by subjecting the syndiotactic polystyrene to cross-link described below and adjusting the degree of cross-linking of the syndiotactic polystyrene. Appropriate conditions for adjusting the degree of crystallinity and the cross-link can be readily obtained from known data or a simple pretest.

Syndiotactic polystyrene can be produced by a method of polymerizing a styrene monomer with a metallocene catalyst, a method described in Japanese Patent No. 3135082, or the like.

Use of syndiotactic polystyrene permits formation of a bearing having a particularly low coefficient of dynamic friction in LLC mainly composed of an aqueous solution of ethylene glycol, that is, a bearing exhibiting a particularly high slidability in LLC. Use of syndiotactic polystyrene also permits preparation of a molding material for bearing exhibiting excellent moldability and formation of a bearing having a low specific gravity and exhibiting particularly excellent heat resistance, chemical resistance, and dimensional stability.

The range of the molecular weight of syndiotactic polystyrene is not particularly restricted as long as the syndiotactic polystyrene can be made to have a storage elastic modulus of 1×10⁶ Pa or more at 260° C. The larger the molecular weight, the more the enhancement in abrasion resistance, short-term heat resistance, long-term heat resistance, cold temperature resistance, and chemical resistance, whereas the larger the degradation in moldability. In consideration of these properties, molecular weight is optimally selected.

Alternatively, a polymer constituting a molding material for bearing according to the present invention may also be a mixture of two or more polymer compounds selected from the group consisting of the homopolymers of cyclic olefin, and the copolymers of cyclic olefin, and the syndiotactic polystyrene.

Alternatively, the polymer may also be a cross-linked product obtained by subjecting a polymer of the cyclic olefin and/or a polymer composed of syndiotactic polystyrene to a cross-linking reaction (a fifth aspect of invention of the present application). Subjecting such a polymer or polymers to a cross-linking reaction is preferable because the occurrence of creep is reduced (creep resistance is enhanced) in a bearing obtained by using the polymer or polymers and the bearing also exhibits enhanced fatigue strength, increased elasticity modulus and enhanced mechanical strength at a high temperature of about 100° C., and enhanced short-term heat resistance.

Examples of the cross-linking reaction include thermal cross-linking, silane cross-linking, radiation cross-linking using ionizing radiation, and the like. Radiation cross-linking is preferred because the degree of cross-linking is easily controlled.

Examples of the radiation include an electron beam, y rays, and the like. A required radiation dose is a dose at which a polymer is made to have a storage elastic modulus of 1×10⁶ Pa or more at 260° C. However, the specific radiation dose varies in accordance with the properties of a polymer such as the type or molecular weight, the presence of a cross-linking agent, the type of a cross-linking agent, the presence of a filler, the type of a filler, or the like. Thus, the specific radiation dose is not restricted. As described below, a preferred radiation dose is a dose required for making a bearing containing a cross-linked polymer have a storage elastic modulus (dynamic viscoelastic modulus) of 1×10⁶ to 1×10¹² Pa at 260° C. The specific range of the radiation dose can be readily determined by a pretest where radiation dose is varied.

When the polymer is cyclic polyolefin, a cross-linking agent is preferably added for promoting radiation cross-linking. When the polymer is syndiotactic polystyrene, radiation cross-linking tends to be achieved without addition of a cross-linking agent. Addition of a cross-linking agent can cause problems such as cost increase, gas generation caused by decomposition of the cross-linking agent, embrittlement of a molded product, and difficulty in conducting injection molding due to separation of the cross-linking agent or the like. For these reasons, syndiotactic polystyrene is preferred in view of the fact that radiation cross-linking tends to be achieved without addition of a cross-linking agent.

A molding material for bearing according to the present invention contains a solid lubricant. The presence of a solid lubricant decreases the friction coefficient of a bearing and enhances the slidability of the bearing. Additionally, this decrease in the friction coefficient results in a decrease in the amount of abrasion, thereby enhancing the abrasion resistance of the bearing.

Examples of the solid lubricant include molybdenum disulfide, ultrahigh molecular weight polyethylene, aramid powder, and fluorine resins. Of these solid lubricants, fluorine resins are preferable because fluorine resins exhibit excellent chemical resistance and considerably enhance slidability. Among fluorine resins, PTFE is particularly preferable because PTFE considerably enhances the slidability of a bearing (a sixth aspect of invention of the present application).

When PTFE is used, the composition ratio of PTFE to a molding material for bearing according to the present invention is not particularly restricted and generally within the range of 0.1 to 90 mass %. When the composition ratio is less than 0.1 mass %, the effect of enhancing the slidability or the abrasion resistance of a bearing is often not expected. When the composition ratio is more than 90 mass %, moldability is degraded. To achieve excellent slidability and abrasion resistance in a bearing and excellent moldability in a molding material, the composition ratio is more preferably within the range of 1 to 30 mass %.

When the polymer is syndiotactic polystyrene, addition of molybdenum disulfide to a solid lubricant is preferable because a solid lubricant containing molybdenum disulfide enhances the stiffness of a bearing at normal temperature.

A molding material for bearing according to the present invention includes, as main components, the polymer and the solid lubricant. Specifically, the molding material contains the polymer and the solid lubricant as indispensable components, and in addition to these components, the molding material may further contain another resin, another material, or the like as long as achievement of the object of the present invention is not inhibited. For example, to enhance the mechanical strength, the creep resistance, and the like of a bearing, a molding material for bearing according to the present invention may further contain one or more reinforcing materials (a seventh aspect of invention of the present application).

Examples of the reinforcing materials include glass fillers such as glass fiber and spherical glass particles; and inorganic fillers such as carbon fiber, calcium carbonate, talc, silica, alumina, aluminum hydroxide, and the like. Addition of a glass filler is preferred in the case where cyclic polyolefin or syndiotactic polystyrene is a cross-linked product obtained by radiation cross-linking because a bearing having a low friction coefficient is obtained in spite of the addition of a glass filler.

Examples of the glass fillers include ECS-187 manufactured by Nippon Electric Glass Co., Ltd., Glass Bubbles manufactured by 3M Company, and CRYSTALITE CMC12S, which is silica manufactured by Tatsumori Ltd. The preferred range of the content of glass filler is 1 to 65 mass % on the basis of the total mass of a bearing.

Examples of optional components that can be added to a molding material for bearing according to the present invention as long as achievement of the object of the present invention is not inhibited include, other than the inorganic filler described above, an organic reinforcing material, a heat-resistant agent, a stabilization agent, and an antioxidizing agent.

A molding material for bearing according to the present invention is obtained by mixing the components described above. The mixing can be conducted in a standard manner with a double-shaft mixing machine or the like.

The present invention provides, in addition to the molding material for bearing described above, a bearing obtained by molding the molding material for bearing (an eighth aspect of invention of the present application). A bearing according to the present invention is obtained by molding a molding material according to the present invention. The mixing described above and this molding may be conducted at the same time.

As described above, the polymer is preferably cross-linked by radiation irradiation or the like. This cross-linking may be conducted at any time before the mixing, after the mixing, or after the molding. However, since the molding is conducted with difficulty after the cross-linking, the cross-linking is preferably conducted after the molding. For example, when the cross-linking is conducted by radiation irradiation, a method of subjecting a molded product to radiation irradiation is preferable.

A bearing according to the present invention preferably has a storage elastic modulus in the range of 1×10⁶ to 1×10¹² Pa at 260° C. Herein, the storage elastic modulus is a value determined with a viscoelasticity measuring instrument at a heating rate of 10° C./min. The storage elastic modulus varies in accordance with the molecular weight or the proportion of components constituting the mixture, degree of cross-linking, the presence of filler, the type of filler, or the like. By adjusting these conditions, a desired storage elastic modulus can be obtained.

The present invention also provides a submersible pump including the bearing described above (a ninth aspect of invention of the present application). The bearing constituting such a submersible pump exhibits high slidability, excellent abrasion resistance, good long-term heat resistance, good long-term cold temperature resistance, excellent chemical resistance, and excellent short-term heat resistance. Therefore, in particular, this submersible pump is suitably used as submersible pumps for cooling water cycling in automobiles and automotive coolers.

### ADVANTAGES

A molding material for bearing according to the present invention does not cause the problem of SOx generation and is excellent in moldability. By molding this molding material for bearing, a bearing can be formed that has high slidability, excellent abrasion resistance, good long-term heat resistance, good long-term cold temperature resistance, and chemical resistance and short-term heat resistance that are equal to or higher than those of a bearing formed with polyphenylene sulfide. A bearing according to the present invention has high slidability, excellent abrasion resistance; chemical resistance and short-term heat resistance that are equal to or higher than those of a bearing formed with polyphenylene sulfide; and excellent long-term heat resistance.

### BEST MODES FOR CARRYING OUT THE INVENTION

Hereinafter, best modes for carrying out the present invention are described with reference to EXAMPLEs. The present invention is not restricted to EXAMPLEs described below and modifications can be made without departing from the spirit of the present invention.

### EXAMPLES

### Examples 1 to 4 and Comparative Example 1

### Preparation of Molding Material for Bearing

In EXAMPLEs 1 to 3, a cyclic polyolefin having the following structure (manufactured by MITSUI CHEMICALS, INC., trade name: APEL 6013T) was used as a polymer. This polymer was cross-linked by radiation irradiation at 240 KGy and the resultant polymer had a storage elastic modulus of 2×10⁶ Pa at 260° C. The storage elastic modulus was determined with a dynamic viscoelasticity measuring instrument (DVA-200 manufactured by IT Keisoku Seigyo, Co. Ltd.) at a heating rate of 10° C./min. Hereinafter, the storage elastic modulus was determined in the same manner.

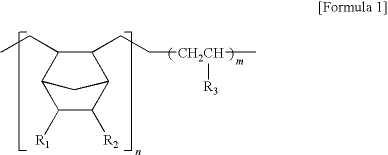

In the formula, R₁ and R₂ each represents a hydrogen atom or a hydrocarbon group; R₃ represents a hydrogen atom, a hydrocarbon group, or a hydrocarbon group substituted by a polar group such as halogen, a hydroxyl group, an ester group, an alkoxy group, a cyano group, an amide group, an imide group, or a silyl group. For a solid lubricant, PTFE powder (manufactured by DAIKIN INDUSTRIES, LTD, trade name: Rublon L-5) was used. The materials described above were mixed with the mixing proportions shown in Table I below and the resultant mixtures were used as molding materials for bearing.

In EXAMPLE 4, ECS03T-289 composed of 65 mass % of a cyclic polyolefin (APEL 6013T), 5 mass % of PTFE, and 30 mass % of glass filler and manufactured by Nippon Electric Glass Co., Ltd. was used as a molding material for bearing.

In COMPARATIVE EXAMPLE 1, an abrasion grade AMORVON WL-30 (trade name, manufactured by DIC Corporation) composed of 65 mass % of polyphenylene sulfide (PPS), 5 mass % of PTFE, and 30 mass % of glass filler was used as a molding material for bearing.

### [Preparation and Measurement of Test Plates]

Each of the molding materials for bearing described above was mixed and heated with a double-shaft mixing machine and subjected to injection molding with an electric injection molding machine ES-18 (manufactured by Sumitomo Heavy Industries, Ltd.) to provide a plate with a thickness of 2 mm. The plate was irradiated with an electron beam at a radiation dose shown in Table I to prepare a test plate.

The resultant test plate was placed in an atmosphere of air, water, or LLC (a 50% aqueous solution of AUTOINCOOLANT95 (trade name, amine-free coolant) manufactured by AUTOBACS SEVEN CO., LTD.) The test plate was in contact with an end face of a cylinder that was constituted by SUS304 stainless steel having a diameter of 8 mm at 23° C. under a load of 1.67 MPa. In this state, the cylinder was rotated at 1500 rpm for 10 minutes and a coefficient of dynamic friction of the test plate was measured in a region where a rotational force was stabilized. Additionally, the test plate was also measured for short-term heat resistance, long-term heat resistance and chemical resistance, and storage elastic modulus at 260° C. by the following measurement methods. The measurement results are shown in Table I.

### [Method for Measuring Short-Term Heat Resistance]

Bearings were produced with materials having the same mixing proportions as those of materials for forming test plates for measuring coefficients of dynamic friction. Each of the materials was mixed and heated with a double-shaft mixing machine and subjected to injection molding with an electric injection molding machine ES-18 (manufactured by Sumitomo Heavy Industries, Ltd.) to provide a bearing having an outer diameter of 11.5 mm, an inner diameter of 9.6 mm, and a length of 20 mm. The resultant bearing was irradiated with an electron beam at a radiation dose shown in Table I. The thus-produced bearings were heated in a thermostatic bath at 300° C. for 10 minutes and the presence of melting was inspected. A bearing that was melted was evaluated as Poor, a bearing that was not melted but deformed was evaluated as Fair, and a bearing that was neither melted nor deformed was evaluated as Good.

### [Method for Measuring Long-Term Heat Resistance and Chemical Resistance]

Bearings obtained by the same method as in the measurement of short-term heat resistance were immersed in LLC at 100° C. for 1000 hours. The bearings were inspected for the presence of a crack and bearings having no cracks were evaluated as Good.

TABLE I

| | | | | | Comparative |
|---|---|---|---|---|---|
| | Example 1 | Example 2 | Example 3 | Example 4 | example 1 |
| Type of polymer | APEL 6013T (cyclic polyolefin) | | | | PPS |
| Mixing proportion of | 100 | 100 | 100 | 65 | 65 |
| polymer | | | | | |
| Mixing proportion of | 5 | 10 | 20 | 5 | 5 |
| PTFE | | | | | |
| Mixing proportion of | — | — | — | 30 | 30 |
| glass filler | | | | | |
| Radiation dose (KGy) | 240 | 240 | 240 | 240 | — |
| Friction coefficient (air) | 0.093 | 0.046 | 0.056 | 0.13 | 0.144 |
| Friction coefficient (LLC) | 0.028 | 0.027 | 0.03 | 0.04 | 0.106 |
| Friction coefficient (water) | 0.027 | 0.063 | 0.073 | 0.085 | 0.115 |
| Long-term heat resistance | Good | Good | Good | Good | Good |
| and chemical resistance | | | | | |
| Short-term heat | Fair | Fair | Fair | Good | Poor |
| resistance | | | | | |

* Mixing proportions in Table I are based on mass.

The results in Table I show that the molded products (bearings) of EXAMPLEs 1 to 4 that included cross-linked products obtained by subjecting cyclic polyolefin to radiation cross-linking had lower friction coefficients and higher slidability than the molded product of COMPARATIVE EXAMPLE 1 that was composed of polyphenylene sulfide. Additionally, the molded products of EXAMPLEs 1 to 4 also exhibited excellent long-term heat resistance and chemical resistance, and excellent short-term heat resistance. In particular, the bearing of EXAMPLE 4 that contained glass filler had excellent short-term heat resistance.

### Examples 5 to 10

### Preparation of Molding Material for Bearing

Molding materials for bearing were prepared by mixing the following polymers, solid lubricant, reinforcing materials, and additives as shown in Table II.

### (Polymer)

Syndiotactic polystyrene (manufactured by Idemitsu Kosan Co., Ltd., trade name: XAREC 104, storage elastic modulus at 260° C.: 1×10⁶ Pa)

Syndiotactic polystyrene containing 30 mass % of glass fiber (manufactured by Idemitsu Kosan Co., Ltd., trade name: XAREC 131, storage elastic modulus at 260° C.: 5×10⁷ Pa)

Cyclic polyolefin (manufactured by MITSUI CHEMICALS, INC., trade name: APEL 6015T, storage elastic modulus at 260° C.: molten)

In Table II, these polymers are described as their trade names.

### (Solid Lubricant)

PTFE powder (manufactured by DAIKIN INDUSTRIES, LTD, trade name: Rublon L-5)

### (Reinforcing Materials)

Carbon fiber (manufactured by Toray Industries, Inc., trade name: TORAYCA chopped fiber TV14-006)

Glass fiber (manufactured by Nippon Electric Glass Co., Ltd., trade name: ECS287)

### (Additives)

Cross-linking agent: DAMGIC (manufactured by SHIKOKU CHEMICALS CORPORATION)

Antioxidizing agent: (manufactured by Ciba-Geigy Ltd., trade name: Irganox 1010)

Molybdenum disulfide (manufactured by SUMICO LUBRICANTCO., Ltd., trade name: molypowder PC)

Anti-crosslinking agent (manufactured by NIPPON FINE CHEMICAL CO., LTD., trade name: NONFLEXALBA)

### [Preparation and Measurement of Test Plates]

Each of the molding materials for bearing described above was mixed and heated with a double-shaft mixing machine and subjected to injection molding with an electric injection molding machine ES-18 (manufactured by Sumitomo Heavy Industries, Ltd.) to provide a plate with a thickness of 2 mm. The plate was irradiated with an electron beam at a radiation dose shown in Table II to prepare a test plate.

The resultant test plate was placed in the atmosphere of LLC (a 50% aqueous solution of AUTOINCOOLANT95 (trade name, amine-free coolant) manufactured by AUTOBACS SEVEN CO., LTD.) As in EXAMPLE 1, the test plate was measured for a coefficient of dynamic friction. Additionally, as in EXAMPLE 1, the test plate was also measured for short-term heat resistance, long-term heat resistance and chemical resistance, and dynamic viscoelasticity. The measurement results are shown in Table II.

TABLE II

| | Example 5 | Example 6 | Example 7 | Example 8 | Example 9 | Example 10 |
|---|---|---|---|---|---|---|
| Type of polymer | XAREC 131 | XAREC 131 | XAREC 131 | XAREC 104 | APEL 6015T | APEL 6015T |
| Mixing proportion of | 70 | 70 | 70 | 100 | 100 | 100 |
| polymer | | | | | | |
| Mixing proportion of | 5 | 5 | 5 | 5 | 5 | 5 |
| PTFE | | | | | | |
| Type of reinforcing | Glass fiber | Glass fiber | Glass fiber | Carbon fiber | Carbon fiber | Glass fiber |
| material | | | | | | |
| Mixing proportion of | 30 | 30 | 30 | 40 | 40 | 40 |
| reinforcing material | | | | | | |
| Mixing proportion of cross- | — | — | 4/0.01 | — | 5/0.1 | 5/0.1 |
| linking agent/anti- | | | | | | |
| crosslinking agent | | | | | | |
| Mixing proportion of | — | — | — | — | 1 | 1 |
| antioxidizing agent | | | | | | |
| Mixing proportion of | — | 2 | — | — | — | — |
| molybdenum disulfide | | | | | | |
| Radiation dose (KGy) | 240 | 240 | 240 | 240 | 240 | 240 |
| Friction coefficient (LLC) | 0.0011 | 0.0013 | 0.0012 | 0.0010 | 0.0028 | 0.017 |
| Long-term heat resistance | Good | Good | Good | Good | Good | Good |
| and chemical resistance | | | | | | |
| Short-term heat resistance | Fair | Fair | Good | Fair | Good | Good |
| Storage elastic modulus × | 8 | 6 | 20 | 8 | 12 | 10 |
| 10⁶ Pa | | | | | | |

* Mixing proportions in Table II are based on mass.

The results in Table II show that the molded products (bearings) of EXAMPLEs 5 to 10 that included cross-linked products obtained by subjecting syndiotactic polystyrene and cyclic polyolefin to radiation cross-linking and PTFE had low friction coefficients in LLC and high slidability. Additionally, these molded products exhibited excellent long-term heat resistance and chemical resistance, and excellent short-term heat resistance.

Comparison between EXAMPLEs 5 and 6 in which syndiotactic polystyrene was used and EXAMPLEs 9 and 10 in which cyclic polyolefin was used shows that, in the case of using syndiotactic polystyrene, excellent long-term heat resistance and chemical resistance can be achieved without addition of a cross-linking agent. In EXAMPLE 7 in which syndiotactic polystyrene was used and a cross-linking agent was added, excellent short-term heat resistance was obtained as well as excellent long-term heat resistance and chemical resistance.

While the present invention has been described in detail with reference to specific embodiments thereof, it will be apparent to those skilled in the art that various changes and modifications can be made without departing from the spirit and scope of the present invention.

This application is based on Japanese Patent Applications No. 2006-231060 filed Aug. 28, 2006 and No. 2007-048813 filed Feb. 28, 2007, which are incorporated by reference herein in their entirety. All the references cited in this application are incorporated by reference in their entirety.

1. A molding material for bearing comprising, as main components, a polymer that does not contain sulfur in a main chain and has a storage elastic modulus of 1×10⁶ Pa or more at 260° C. and a solid lubricant, wherein a molded product obtained by molding the molding material has a coefficient of dynamic friction of 0.05 or less against stainless steel in a 50% aqueous solution of ethylene glycol at 30° C.

2. The molding material for bearing according to claim 1, wherein the polymer is a polymer of cyclic olefin.

3. The molding material for bearing according to claim 1, wherein the cyclic olefin is cyclopentene, 2-norbornene, or a compound including a cyclotetradodecene-based monomeric structure.

4. The molding material for bearing according to claim 1, wherein the polymer is syndiotactic polystyrene.

5. The molding material for bearing according to claim 1, wherein the polymer is a cross-linked product.

6. The molding material for bearing according to claim 1, wherein the solid lubricant is polytetrafluoroethylene.

7. The molding material for bearing according to claim 1, further comprising a reinforcing material.

8. A bearing comprising a molded product obtained by molding the molding material for bearing according to claim 1.

9. A submersible pump comprising the bearing according to claim 8.
